(19) United States
(12) Patent Application Publication
(10) Pub. No.: US 2018/0369805 A1
(43) Pub. Date: Dec. 27, 2018

(54) IN-MOLD PRINTING OF TUBES

(71) Applicant: CHICO TECHNOLOGIES LLC, Burlingame, CA (US)

(72) Inventor: Yunqi TIAN, Fremont, CA (US)

(21) Appl. No.: 16/065,673

(22) PCT Filed: Dec. 19, 2016
(86) PCT No.: PCT/US2016/067565

§ 371 Date: Jun. 22, 2018

Related U.S. Application Data
(60) Provisional application No. 62/387,423, filed on Dec. 23, 2015.

(51) Int. Cl. B01L 3/00; B29C 45/17

(52) U.S. Cl. CPC B01L 3/5082; B01L 3/5453; B01L 2300/028; B01L 2200/12; B01L 2300/021; B29C 45/1704

(57) ABSTRACT

Described herein are injection molded containers and methods for in-mold labeling of the containers. More specifically, injection molded laboratory or medical containers such as centrifuge tubes, cryogenic tubes, blood collection tubes, sample holding tubes, and sample storage tubes, and methods for their mass production with in-mold labels is described.

### CROSS REFERENCE TO RELATED APPLICATIONS

This application claims priority benefit of U.S. Provisional Application No. 62/387,423 filed Dec. 23, 2015, the contents of which are incorporated herein by reference in their entirety.

### FIELD

This application relates to injection molded containers and methods for in-mold labeling of the containers. More specifically, this application relates to injection molded laboratory or medical containers such as centrifuge tubes, cryogenic tubes, and blood collection tubes, and methods for their mass production with in-mold labels.

### BACKGROUND

Injection molding is a process for producing manufactured products from a resin material. After the product is designed, a mold is created, usually from a metal such as steel or aluminum. The mold is precision-machined to form the features of the product. In order to create the product, the resin material is heated and forced by injection into the mold cavity, where it cools and conforms to the configuration of the mold cavity.

An injection molding machine typically includes a hopper in which the resin material is stored in granular form. The resin material is heated and fed into the mold via one or more feed lines and forced into the mold cavity by a ram, plunger, reciprocating screw, or other type of injector. Various types of medical and laboratory tubes, e.g., centrifuge tubes, cryogenic tubes, sample storage tubes, etc., can be made using the injection molding process. These tubes often include volume measuring indicia (e.g., graduation markings), labels, or other types of information such as barcodes. The graduation markings, labels, or barcodes are conventionally placed on the tubes by printing, stamping, or laser etching, which have limited resistance, and may wear off when exposed to chemical reagents and low temperature environments.

Another drawback of above-mentioned processes is that they are secondary operations. The tubes must first be manufactured and then the label, barcodes, etc., added in a totally different operation. This secondary operation adds cost to the product. In some instances, raised markings may be formed on the tubes to provide a tactile sensation or tactile readability of the markings, and/or provide a slip-resistant holding for the tubes. However, printing techniques capable of embossing such makings cannot currently be used in high volume production.

Accordingly, it would be beneficial to have medical and laboratory tubes with increased resistance to various chemical and environmental conditions. It would also be useful to have methods for cost-efficient mass production and labeling of tubes.

### SUMMARY

Described herein are various injection molded containers and methods for their mass production with in-mold labels. The injection molded container may be a centrifuge tube, a cryogenic tube, a sample holding tube, a sample storage tube, or other type of tube used in a scientific or medical laboratory. During their production, batches of injection molded containers can be made and labeled. In general, the CV (coefficient of variation) value between these batches should be low. For example, the CV value may range from about 3% to about 5%.

The injection molded containers may include a tube body having an open top portion, a closed bottom portion, and a side wall having a wall thickness, the side wall extending between the top portion and the bottom portion of the tube body; and an in-mold label. The injection molded containers may further include a cap for covering the open top portion of the tube body. As stated above, the container may be a centrifuge tube, a cryogenic tube, a blood collection tube, a sample holding tube, or a sample storage tube. The injection molded containers may be made from any suitable polymeric material, e.g., polyethylene or polypropylene.

The side wall may have a wall thickness at the bottom portion of the tube body ranging from about 0.10 mm to about 2.0 mm. For example, the wall thickness at the bottom portion may be about 0.20 mm, about 0.25 mm, about 0.50 mm, about 0.75 mm, about 1.0 mm, about 1.25 mm, about 1.50 mm, or about 2.0 mm. The side wall may have a wall thickness at the top of the tube body ranging from about 0.10 mm to about 2.0 mm. For example, the wall thickness at the top portion may be about 0.20 mm, about 0.25 mm, about 0.50 mm, about 0.75 mm, about 1.0 mm, about 1.25 mm, about 1.50 mm, or about 2.0 mm. In some instances, the wall thickness of the side wall at the bottom portion of the tube body is greater than the wall thickness of the side wall at the top portion of the tube body. For example, at the bottom portion the wall thickness of the side wall may be about 2.0 mm, and at the top portion the wall thickness of the side wall may be about 0.10 mm. The change in wall thickness may gradually decrease from the bottom to the top portion of the tube body.

The injection molded containers generally include a label placed during the molding process (an in-mold label). The in-mold label may comprise the same material as the container, or a different material. It may be beneficial for the container and the in-mold label to comprise the same material. For example, it may be beneficial for the container and the in-mold label to comprise polypropylene. The in-mold label may comprise measurement markings, a barcode, or other design.

The in-mold label may be placed in any suitable location on the injection molded container. In some variations, the in-mold label is disposed within the side wall of the tube body. Here the in-mold label may include measurement markings and be disposed within the side wall of a tube, e.g., a centrifuge tube. In other variations, the in-mold label may comprise a barcode and be disposed within the side wall or the bottom portion of a tube, e.g., a cryogenic tube.

Methods for manufacturing injection molded containers comprising in-mold labels are further disclosed herein. The methods may include the steps of injection molding batches of containers, the containers comprising tube body having a top portion, a bottom portion, and a side wall extending therebetween; and placing a label within the tube body by in-mold labeling. The types of containers that can be made using this method include without limitation, centrifuge tubes, cryogenic tubes, blood collection tubes, sample holding tubes, sample storage tubes, etc. The in-mold label that is placed within the tube body may include measurement markings, a barcode, or other design. The CV value between the batches of containers may range from about 3% to about 5%.

### BRIEF DESCRIPTION OF THE DRAWINGS

FIGS. 1A-1C depict exemplary in-mold labels comprising a combination of text in the form of measurement markings and logos.

FIGS. 2A-2B depict exemplary in-mold labels comprising measurement markings and/or a barcode.

### DETAILED DESCRIPTION

Described herein are in-mold labeled containers, e.g., containers for medical and/or laboratory use, and methods for mass producing batches of the containers with in-mold labels. In-mold labeling is a process by which a product's label is secured to the product during the molding process so that the label becomes an integral part of the product. The labeling accomplished in this manner is generally resistant to degradation by chemicals, solvents, and low temperature environments. Additionally, batches of the labeled containers are substantially homogeneous, having a CV value ranging from about 3% to about 5%. Although injection molding is primarily described, the containers may also be made and labeled using blow molding processes.

### Injection Molded Containers

Various types of containers may be injection molded with a label using the manufacturing methods described herein. For example, containers such as centrifuge tubes, cryogenic tubes, vials, sample holding tubes, sample storage tubes, test tubes, blood collection tubes, and syringes may be formed. Other types of laboratory and medical containers may also be formed. The containers may be various tubes that are used for general laboratory use, cryogenically stored samples, stem cell and cell line production and storage, in vitro fertilization, blood products, pharmaceutical production, etc. Batches of the labeled containers are substantially homogeneous, having a CV value ranging from about 3% to about 5%, as stated above. In one variation, the batches of containers have a CV value of about 3%. In another variation, the batches of containers have a CV value of about 4%. In a further variation, the batches of containers have a CV value of about 5%.

The injection molded containers generally include a tube body having an open top portion (e.g., open top end so that substances can be placed into the container), a closed bottom portion, and a side wall having a wall thickness, the side wall extending between the top portion and the bottom portion of the tube body; and an in-mold label. The side wall generally defines an interior chamber. The injection molded containers may have any size and holding volume suitable for their intended use. Caps may also be included with the containers to cover the open top portion of the tube body.

The tube body of the container may also have any suitable cross-sectional shape. For example, the tube body may have a cross-section that is cylindrical, square, triangular, ellipsoid, etc. In some variations, the bottom portion of the tube is tapered. The injection molded containers may be made from any suitable polymeric material, as further described below for the in-mold labels. In one variation, the injection molded containers are made from polyethylene. In another variation, the injection molded containers are made from polypropylene. The tube body of the container and the in-mold label may be made from the same polymeric material or different polymeric materials. It may be beneficial for integration of the label with the container during the molding process to have them comprise the same material, or a material having a similar glass transition temperature.

The side wall may have a wall thickness at the bottom portion of the tube body ranging from about 0.10 mm to about 2.0 mm. For example, the wall thickness at the bottom portion may be about 0.20 mm, about 0.25 mm, about 0.50 mm, about 0.75 mm, about 1.0 mm, about 1.25 mm, about 1.50 mm, or about 2.0 mm. The side wall may have a wall thickness at the top of the tube body ranging from about 0.10 mm to about 2.0 mm. For example, the wall thickness at the top portion may be about 0.20 mm, about 0.25 mm, about 0.50 mm, about 0.75 mm, about 1.0 mm, about 1.25 mm, about 1.50 mm, or about 2.0 mm. In some instances, the wall thickness of the side wall at the bottom portion of the tube body is greater than the wall thickness of the side wall at the top portion of the tube body. For example, at the bottom portion the wall thickness of the side wall may be about 2.0 mm, and at the top portion the wall thickness of the side wall may be about 0.10 mm. The side wall of the injection molded containers may have a wall thickness that changes between the bottom portion of the tube body and the top portion of the tube body. Some variations of the container may have a wall thickness that gradually decreases from the bottom to the top portion of the tube body.

The in-mold label may be placed in various locations on the container. For example, the label may be placed on the side wall or on the bottom portion of the container. Exemplary in-mold labels include without limitation, measurement markings (such as graduation markings on a centrifuge tube), barcodes and/or other printed text or graphical designs.

Some variations of the container may include an injection molded centrifuge tube comprising a top portion, a bottom portion, a side wall having a wall thickness, the side wall extending between the top and bottom portions, and an in-mold label, where the in-mold label comprises measurement markings, and wherein the wall thickness of the side wall changes between the top and the bottom portions. It may be useful for a centrifuge tube to include a thicker bottom portion so that it may be weighted during the centrifugation process.

Other variations of the container may include an injection molded cryogenic tube comprising a top portion, a bottom portion, a side wall extending between the top and bottom portions, and an in-mold label, where the in-mold label comprises a barcode. The barcode may be disposed within the side wall of the cryogenic tube. However, it may be useful for high throughput scanning of information to have the barcode disposed within the bottom portion.

### In-Mold Labels

The in-mold labels described herein may comprise measurement markings or other types of information in a barcode format. The in-mold labels may have any suitable dimensions, e.g., any length, width, and thickness suitable for the container to be labeled. In general, the labels comprise a film have a thickness ranging from about 0.01 mm to about 0.15 mm. For example, the in-mold labels may have a thickness of about 0.01 mm, about 0.05 mm, about 0.10 mm, or about 0.15 mm.

The labels for in-mold labeling may be made from any suitable polymeric material. Exemplary polymers include without limitation, a polyolefin, a polyacrylate, a polystyrene, a polyamide, a polyvinyl alcohol, a poly(alkylene acrylate), a poly(ethylene vinyl alcohol), a poly(alkylene vinyl acetate), a polyurethane, a polyacrylonitrile, a polyester, a fluoropolymer, a polysulfone, a polycarbonate, a styrene-maleic anhydride copolymer, a styrene-acrylonitrile copolymer, methacrylic acid, cellulosics, or combinations thereof. In one variation, the polymer comprises polypropylene. The label and the container may comprise the same or different polymeric material, as stated above.

The polyolefins which can be utilized as the polymer material include polymers and copolymers of olefin monomers containing 2 to about 12 carbon atoms such as ethylene, propylene, 1-butene, etc., or blends of mixtures of such polymers and copolymers. In one variation, the polyolefins comprise polymers and copolymers of ethylene and propylene. In another variation, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer may also be useful. In another variation, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content.

Various polyethylenes can be utilized as the polymer material including low, medium, and high density polyethylenes, and mixtures thereof. The propylene homopolymers which can be utilized as the polymer material, either alone, or in combination with a propylene copolymer as described herein, include a variety of propylene homopolymers such as those having melt flow rates (MFR) from about 0.5 to about 20.

Examples of useful polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 ml/10 min and an elongation at break (ASTM D638) of 15. Grivory CF65 is a nylon 6/12 film grade resin having a melting point of 135° C., a melt flow index of 50 ml/10 min, and an elongation at break in excess of 350%. Grilon CR9 is another nylon 6/12 film grade resin having a melting point of 200° C., a melt flow index of 200 ml/10 min, and an elongation at break at 250%. Grilon XE 3303 is a nylon 6.6/6.10 film grade resin having a melting point of 200° C., a melt flow index of 60 ml/10 min, and an elongation at break of 100%.

Polystyrenes can also be utilized as the polymer material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA).

Polyurethanes also can be utilized as the polymer material. Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Aromatic polyether polyurethanes, aliphatic polyether polyurethanes, aromatic polyester polyurethanes, and aliphatic polyester polyurethanes may also be useful.

Polyesters prepared from various glycols or polyols and one or more aliphatic or aromatic carboxylic acids also are useful polymer materials. Furthermore, acrylate polymers and copolymers and alkylene vinyl acetate resins (e.g., EVA polymers), polycarbonates are obtained by the reaction of bisphenol A and carbonyl chloride, and fluorinated polymers including a thermoplastic fluorocarbon such as polyvinylidene fluoride (PVDF) may be employed.

The labels are generally pre-printed with text and/or a graphical design onto a polymer film. The text is typically customized for the intended container, and may include measurement markings, logos, or data such as serial numbers, barcodes (e.g., 2D barcodes), trademarks, etc., or combinations thereof. The inks used for printing the labels may include commercially available water-based, solvent-based, or radiation-curable inks. The labels are generally cut to the size appropriate for the container to be labeled.

Including these pre-printed labels on the containers during the injection molding process generally protects the printing during product use, e.g., when the container may be subjected to chemicals (e.g., phenol), solvents (e.g., acetone), and low temperature (e.g., liquid nitrogen) environments. The labels may also be variously colored to help with identification of the contents of the containers.

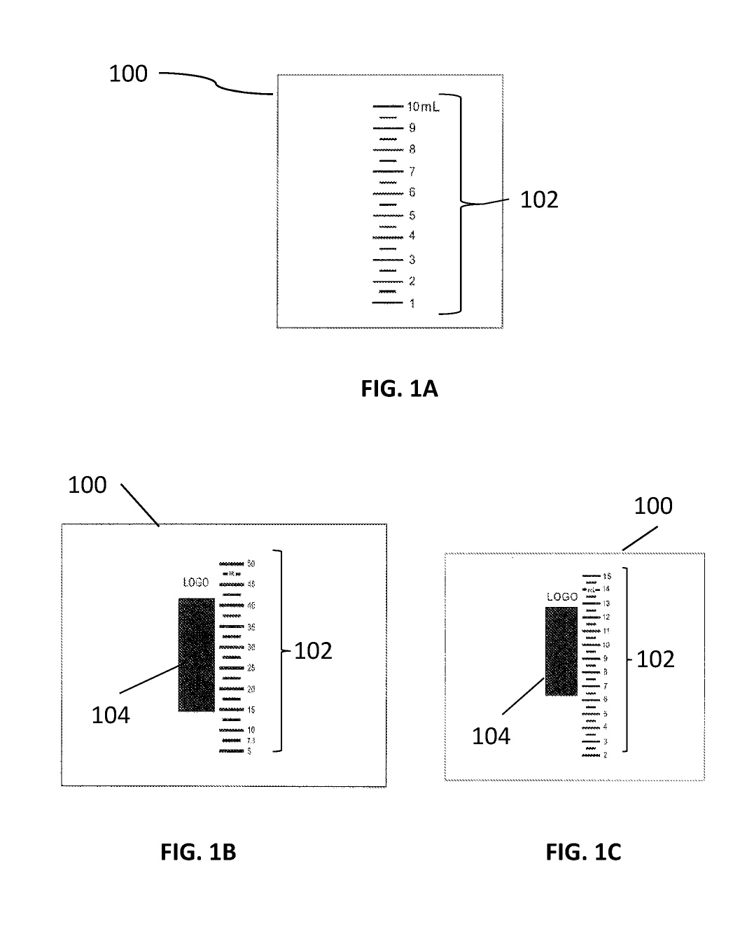

Referring to FIGS. 1A-1C, exemplary labels that may be molded with containers in which volume measurement is useful, e.g., centrifuge tubes, are shown. In the figures, labels (100) include measurement markings (graduation markings) (102). In addition to the measurement markings (102), a design such as a logo (104) may be included.

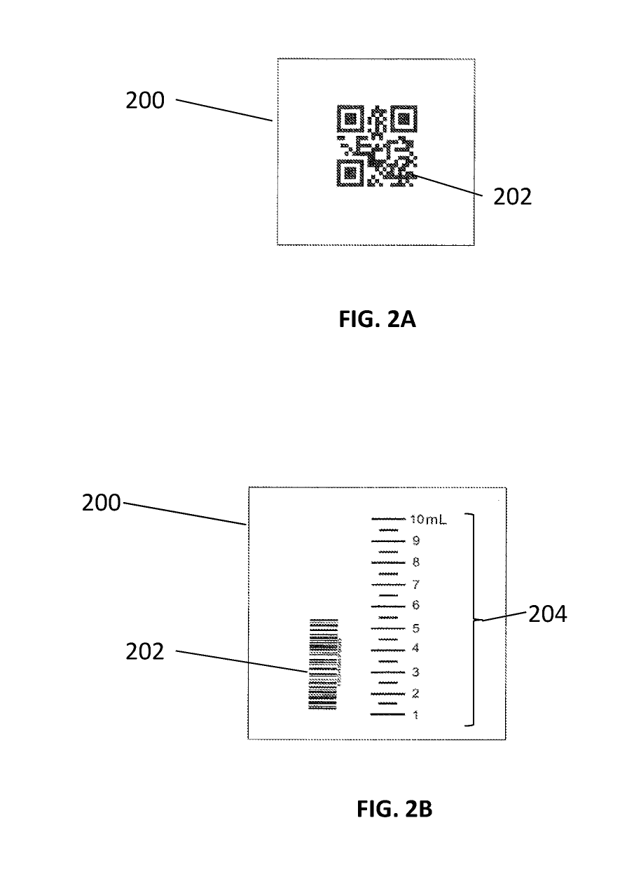

Referring to FIGS. 2A and 2B, exemplary labels comprising barcodes are shown. In the figures, labels (200) include two-dimensional (2D) barcode (202). Measurement markings (204) may also be included in addition to the barcode (202). Although the figures depict a barcode in combination with measurement markings, it is understood that any combination of text, designs, logos, barcodes, etc. may be employed.

### Manufacturing Methods

Methods for manufacturing containers comprising in-mold labels are further described herein. In some variations, a plurality of labels carrying various product identification and description information and/or measuring indicia, e.g., as shown in FIGS. 1A-1C and FIGS. 2A-2B, are die-cut from a master film sheet into the required configuration and loaded into a magazine or other type of loading station. For application to a container, the labels are picked from the magazine by an appropriate transfer means, e.g., vacuum, and inserted into a predetermined label placement area within a plastic forming mold. Retention of the label at the placement area can be achieved by vacuum or the application of charge to the label. When molten polymer material is fed into the mold for forming into the desired container shape, the molten polymer material contacts the pre-positioned label, which is thereupon adhered to the container at the contact area. Some variations of the method include making batches of containers that are substantially similar, and having a CV value ranging from about 3% to about 5%. For example, the batches may have a CV value of about 3%, about 4%, or about 5%. Each batch may comprise two or more containers. Additionally or alternatively, manufacturing of the containers may be automated or robotically assisted.

Various types of containers may be made using the manufacturing methods described herein. For example, containers such as centrifuge tubes, cryogenic tubes, vials, sample holding tubes, sample storage tubes, blood collection tubes, test tubes, and syringes may be made in large quantities (mass produced) and labeled in a cost-efficient manner using the methods described herein. Other types of laboratory and medical containers may also be formed and labeled. One advantage of the method is that batches of the labeled containers can be made to be substantially homogeneous, having a CV value ranging from about 3% to about 5%, as stated above. In one variation, the batches of containers have a CV value of about 3%. In another variation, the batches of containers have a CV value of about 4%. In a further variation, the batches of containers have a CV value of about 5%.

In some variations, the manufacturing method includes injection molding batches of centrifuge tubes, the centrifuge tubes comprising a top portion, a bottom portion, and a side wall extending therebetween; and placing measurement markings on the centrifuge tubes by in-mold labeling. The CV value between the batches may range from about 3% to about 5%. For example, the CV value between the batches of centrifuge tubes may be about 3%, about 4%, or about 5%. Additionally, the centrifuge tubes may be manufactured to have a decrease in thickness between the bottom portion and the top portion.

In other variations, the manufacturing method includes injection molding batches of cryogenic tubes, the cryogenic tubes comprising a top portion, a bottom portion, and a side wall extending therebetween; and placing a barcode on the cryogenic tubes by in-mold labeling. The barcode may be placed in any suitable location, e.g., the side wall or the bottom portion of the cryogenic tube. Placement of the barcode at the bottom of the cryogenic tube may be useful for high throughput reading of the information contained therein, especially high throughput reading of information from batches of cryogenic tubes. The CV value between the batches may range from about 3% to about 5%. For example, the CV value between the batches of cryogenic tubes may be about 3%, about 4%, or about 5%.

1-36. (canceled)

37. A plurality of batches of injection molded containers having a CV value, wherein the CV value between the batches ranges from about 3% to about 5%, wherein each injection molded container comprises:
a tube body having an open top portion, a closed bottom portion, and a side wall having a wall thickness, the side wall extending between the top portion and the bottom portion of the tube body; and
an in-mold label,
wherein the container is a centrifuge tube, a cryogenic tube, a blood collection tube, a sample holding tube, or a sample storage tube.

38. The plurality of batches of claim 37, wherein the injection molded containers are centrifuge tubes.

39. The plurality of batches of claim 37, wherein the injection molded containers are cryogenic tubes.

40. The plurality of batches of claim 37, wherein the tube body of each injection molded container has a cylindrical cross-section.

41. The plurality of batches of claim 37, wherein the bottom portion of the tube in each injection molded container is tapered.

42. The plurality of batches of claim 37, wherein the in-mold label is disposed within the side wall of the tube body in each injection molded container.

43. The plurality of batches of claim 37, wherein the in-mold label is disposed within the bottom portion of the tube body in each injection molded container.

44. The plurality of batches of claim 37, wherein the in-mold label in each injection molded container comprises measurement markings.

45. The plurality of batches of claim 37, wherein the in-mold label in each injection molded container comprises a barcode.

46. The plurality of batches of claim 37, wherein the in-mold label in each injection molded container comprises polypropylene.

47. The plurality of batches of claim 37, wherein the wall thickness of the side wall at the bottom portion of the tube body is greater than the wall thickness of the side wall at the top portion of the tube body in each injection molded container.

48. The plurality of batches of claim 37, wherein the wall thickness at the bottom portion of the tube body in each injection molded container ranges from about 0.1 mm to about 2.0 mm.

49. The plurality of batches of claim 37, wherein the wall thickness at the top of the tube body in each injection molded container ranges from about 0.1 mm to about 2.0 mm.

50. The plurality of batches of claim 37, wherein the wall thickness of the side wall in each injection molded container gradually decreases from the bottom portion to the top portion of the tube body.

51. The plurality of batches of claim 37, further comprising a cap for covering the opening at the top portion of the tube body for each injection molded container.

52. A method for manufacturing centrifuge tubes comprising:
injection molding batches of centrifuge tubes, the centrifuge tubes comprising a top portion, a bottom portion, and a side wall extending therebetween; and
placing measurement markings on the centrifuge tubes by in-mold labeling, wherein a CV value between the batches ranges from about 3% to about 5%.

53. The method of claim 52, wherein the side wall of the centrifuge tubes has a decrease in thickness between the bottom portion and the top portion.

54. A method for manufacturing cryogenic tubes comprising:
injection molding batches of cryogenic tubes, the cryogenic tubes comprising a top portion, a bottom portion, and a side wall extending therebetween; and
placing a barcode on the cryogenic tubes by in-mold labeling, wherein a CV value between the batches ranges from about 3% to about 5%.

55. The method of claim 54, wherein the barcode is placed within the side wall of the cryogenic tube by in-mold labeling.

56. The method of claim 54, wherein the barcode is placed within the bottom portion of the cryogenic tube by in-mold labeling.
